(19) United States
(12) Patent Application Publication
(10) Pub. No.: US 2026/0342571 A1
(43) Pub. Date: Oct. 29, 2026

(54) ZERO-KNOWLEDGE PROOF BASED AUTHENTICATION METHOD

(71) Applicant: Mohammad Rakib Hassan Mullick, Dhaka (BD)

(72) Inventor: Mohammad Rakib Hassan Mullick, Dhaka (BD)

(73) Assignee: Mohammad Rakib Hassan Mullick, Dhaka (BD)

(21) Appl. No.: 19/529,154

(22) Filed: Feb. 4, 2026

Related U.S. Application Data
(60) Provisional application No. 63/795,304, filed on Apr. 26, 2025.

(51) Int. Cl. H04L 9/32

(52) U.S. Cl. CPC H04L 9/3213; H04L 9/3221

(57) ABSTRACT

A method and system for authentication has been disclosed that integrates prover provided data as a part of the authentication token generation process making the authentication token generation process highly unpredictable. The embodiment further discloses exemplary computer implemented GUI, mobile application to utilize the disclosed system and method. The GUI is for receiving inputs to prepare authentication tokens, the mobile application for maintaining, generating various authentication token generation details which help the prover to keep track of authentication details across various servers.

### CROSS-REFERENCE TO RELATED APPLICATIONS

This application claims the benefit of U.S. Provisional Patent Application No. 63/795,304 filed 26 Apr., 2025 which application is hereby incorporated in its entirety by reference.

### BACKGROUND OF THE INVENTION

A major drawback of traditional authentication systems is the reliance on user credentials which are often stored in plaintext or hashed form within the system and that is one of the reason why password databases are primary target for the attackers. Hashing is used to protect the plaintext passwords as protection against such compromises. Hashing methods are generally irreversible meaning there's no possible way to retrieve the input from the output and passwords are stored by using a fixed hashing method. Although there's no straightforward way to retrieve the plaintext password from its hashed form but an attacker can generate a pre-computed hash table of all the possible texts known as rainbow-table which can be used to retrieve the plaintext password. Also a person (an employee leaving an organization) who knows how the password hashing has been designed can construct a rainbow table effectively. Sometimes an additional random generated text referred as salt is added to make hashing robust. Salts are kept in a plaintext form therefore doesn't offer any protection against server compromises. Some hashing algorithms like PBKDF2 parameterized the number of hash iterations and accepts salt as parameter which improves the scenario but still doesn't offer protection against leaking of password databases in case of server compromises or the fact that someone from the organization leaks information, therefore end users need to trust the entity offering the authentication service. End users don't have any control over the password protection technique. Protecting passwords with a fixed hashing method exposes them to potential attacks, as demonstrated by numerous major data breaches in various sectors including banking, trading, aviation etc. These breaches can have severe consequences for organizations including the risk of losing money and privacy (www.haveibeenpwned.com).

A further limitation of traditional authentication system is users often required to share personal data, such as security questions or biometric information during authentication. These requirements raises privacy concerns as organizations may become targets for hacking attempts aimed to steal sensitive information. To improve the security of password based authentication an additional security measure is taken by integrating one-time-password (OTP) utilizing a device that the user/prover posses. This is referred as Two Factor Authentication (2FA). OTP can be sent to a cell phone number through SMS/calling or by a so-called authenticator app that generates a token based on a predetermined hash algorithm and a seed. The predetermined algorithm and the seed are used by both the client and the server.

To address such drawbacks and to enhance user privacy Zero-Knowledge based authentication (ZKBA) appears as a promising alternative. ZKBA relies on cryptographic techniques to verify user identities and shares only the necessary information. However, ZKBA systems are not easy to adapt due to its usability issues. One prime example is the integration of signature based authentication in Web3 platforms where it relies on third-party extensions or apps. Password based authentication is intuitive, user friendly and it doesn't require the know-how of complex digital signature management. Due to the usability, implementation complexity and complex know-hows, digital signature based zero-knowledge authentication remains underutilized and hard to adopt. As Cybersecurity threats continue to evolve, quantum computers are on the rise, effective rainbow-table based attacks will become more realistic. It is crucial for organizations to consider incorporating server-compromise tolerant, quantum proof authentication systems into their digital security strategies to maintain the competitive edge in the ever-changing landscape of digital authentication.

### SUMMARY OF THE INVENTION

According to one of preferred embodiment a zero-knowledge proof based authentication method and a system has been disclosed where the verifier relies on the prover provided procedure for authentication token generation and verification. A prover may use its own defined procedure for generating authentication token or a verifier provided procedure that takes input from the prover and pass those inputs to the procedure as parameters. These so-called parameters comprising data and operations (OPs) will be collectively referred as AlisCave Verifier Data (ACVD). The data part of the ACVD is prover provided and the OPs part is generally verifier provided but also can be prover defined. Before authentication a prover need to register with its unique ID and one or more authentication tokens. The prover sends ACVD or a procedure to the verifier during the authentication and the verifier generates the authentication token and makes authentication decision by comparing the generated authentication token with the stored authentication token. The verifier does not store the received ACVD or the procedure therefore it does not posses any knowledge of how to generate the target authentication token. This approach makes the verifier tolerant to possible credential breaches even if an attacker gains access to the authentication token they cannot use the stored authentication token without proving ownership and it's not feasible to leverage any reasonable rainbow-table based attack due to the dynamic approach of generating authentication token. This process of generating authentication token is similar to password hashing however it adds more to the process by including the possibility of adding additional data like, unique ID, secret, salt in combination of various OPs. An authentication token can be generated at the verifier side as well as at the prover side, as long as the so-called the ACVD are not stored (or remembered) in a permanent storage by the verifier and the ACVD or the procedure is prover provided.

The disclosed computer system and the method for authentication utilizing the present disclosure hereinafter referred as AlisCave Authentication System (ACAS) and AlisCave Authentication Method (ACAM), respectively. The ACAS allows a client application to register and use ACAS as a third-party authentication service provider. One of the disclosed embodiment includes a mobile application called AlisCave Auth Manager that helps keep track of the ACVD. The mobile app require an user to register to the ACAS then generate plurality of authentication token which can be used by the user for login via different applications. The disclosed AlisCave Auth Manager can be used for ephemeral token generation that can be used for authentication. The disclosed mobile application is capable of generating ACVD randomly and the possibility of using an authentication token once.

According to disclosed preferred embodiments a computer implemented method comprising a graphical user interface (GUI) for receiving the ACVD and preparing a procedure for authentication token generation has been shown. Throughout this disclosure the term prover or client or user indicates a party who wants to be authenticated, on the other hand a server or a verifer indicates a party who does the verification and will be used interchangeably.

### BRIEF DESCRIPTION OF DRAWINGS

The present disclosure in accordance with one or more preferred embodiments described in detail with reference to the following figures. The figures are provided for illustration purpose only, not drawn to scale and merely depict typical or example embodiments.

FIG. 1A shows a flowchart of the authentication method and a typical ACAS. FIG. 1B shows a typical flowchart of a prover authenticating itself to the AlisCave authentication system.

FIG. 2A shows a mobile application called AlisCave Auth Manager, how it manages authentication token generation ACVDs and AlisCave token login view. FIG. 2B showing an web-based application accepting ephemeral tokens for user authentication where the ephemeral token is provided by the ACAS.

FIGS. 3A and 3B illustrates an web-based user interface for user registration and login using the disclosed authentication method and the system.

FIG. 4A shows an exemplary payload used by a prover to verify itself to a verifier.

FIG. 4B illustrates an exemplary Python implementation of a procedure that can be used by a verifier as well as by the prover to generate an authentication token.

FIG. 4C shows an example computing device used to implement various embodiments described in the present disclosure.

### DETAILED DESCRIPTION OF THE INVENTION

The terminology used herein is for the purpose of describing particular embodiments only and is not intending to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components and/or groups thereof.

Unless otherwise defined all terms (including technical and scientific terms) used herein have the same meanings as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

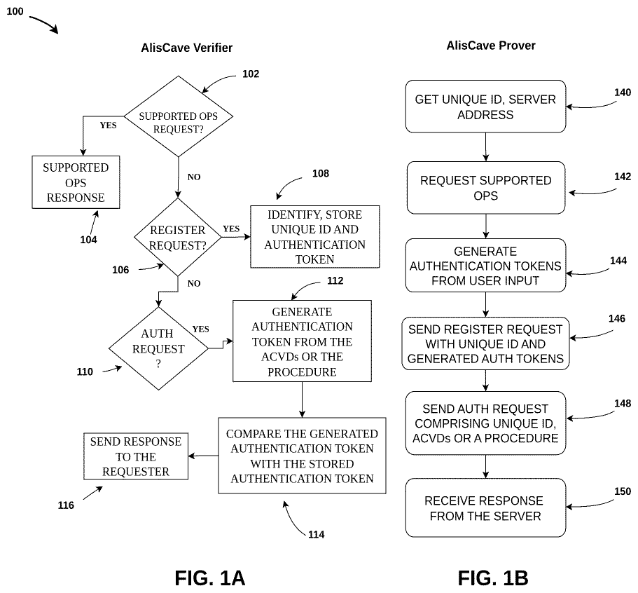

FIG. 1A illustrates a flow diagram of a authentication server utilizing the disclosed authentication method referred as AlisCave Verifier and the FIG. 1B illustrates a mobile application acting as a prover referred as AlisCave Prover (100). The AlisCave Verifier waits for the requests from a prover. Roughly the operation starts when the prover sends a request for supported OPs and the server checks if the request is for supported OPs (102). Typically an web/mobile application fetches its content from an web server. A service provider offers software library/SDK for the developers which allow developers to build client-side application meant to work with a particular server (AlisCave Verifier in this case) . Such libraries can be developed for various platforms like web/desktop/mobile etc., offering APIs for requesting supported OPs from the server and can include codes that prepare the authentication tokens from the user input they received, however some implementation might allow authentication token generation at the server side wherein the server receives the ACVD from the client and uses the ACVD for the authentication token generation. The server sends the list of OPs (104) to the client. If the request is not for supported OPs then it checks if the request is a register request (106). The server handles the register request with a parameter comprising unique ID, a plurality of authentication tokens, few special authentication tokens for account recovery (108). Recovery authentication tokens are only to be used when an user forgets authentication details. The server tries to determine if it receives an authentication request or not (110). It is possible to implement the authentication request with different parameters by keeping the core idea of deriving authentication tokens from the client provided ACVD/procedures. Upon receiving the request the server generates the authentication token by applying the received ACVD or by executing the procedure and finds the stored authentication token for the requested unique ID (112). If both authentication token matches the server responds with a successful authentication response. If the server receives recovery authentication token request then it checks for the recovery tokens (112) and responds to the client if there's a match. Recovery token functionality is required for account recoveries in case users forgets their authentication details or lost access to the AlisCave authentication management mobile app. Some implementation may send unique ID and the ACVD in separate steps. The verifier sends a response to the prover/requester with either a successful or an unsuccessful message (116). The successful response may also contain a randomly generated token if the authentication request includes an indication of ephemeral token generation request. The system marks the generated ephemeral token valid for a limited period of time for the requested prover.

The server can be configured to use as a third-party authenticator wherein the server generates a session id with an unique ID and sends them to the requesting party (116). Some implementation may accept session ID from the third-party application and forward it to the prover in case of successful verification. Some embodiment can utilize well known protocols like OAuth2 for generating and maintaining session tokens. OAuth2 is an open standard used to provide authorization maintenance services for web services. OAuth2 does not explicitly handle username-password based authentication but generates and maintains tokens for an already authenticated session. The server may use each authentication token only once and delete the used authentication token afterwards, in such case the client must update the authentication tokens periodically and the server receives that update request with new batch of authentication tokens.

FIG. 1B illustrates how an exemplary application called AlisCave Prover which authenticates itself to the AlisCave verifier. A prover can be a mobile application or a web application or desktop application or a person using such application etc. The prover takes user input comprising e-mail/userid/unique ID and server address (140). The prover send request for supported OPs to the server (142). The AlisCave prover randomly picks or lets user pick a set of OPs from the possible OPs and provide other possible data as part of preparing ACVD. From the prepared ACVD the app creates an authentication token (144). Users can pick their own secret or the app can generate random secrets on users behalf. Using the same technique the prover may also generate multiple set of authentication tokens to be used for account recovery. As a part of registration, the prover sends registration request (146) to the verifier wherein the request comprising the unique ID and the generated authentication tokens from previous step (144). Some implementation like the mobile app can periodically generate a new batch of authentication tokens and sync with the server for future use. At the time of authentication the prover prepares an authentication/login request comprising an unique ID, a procedure or ACVDs, send to the server (148) and waits for a response from the server (150). If the request was for an ephemeral token then the response may include a ephemeral token to be used with web login.

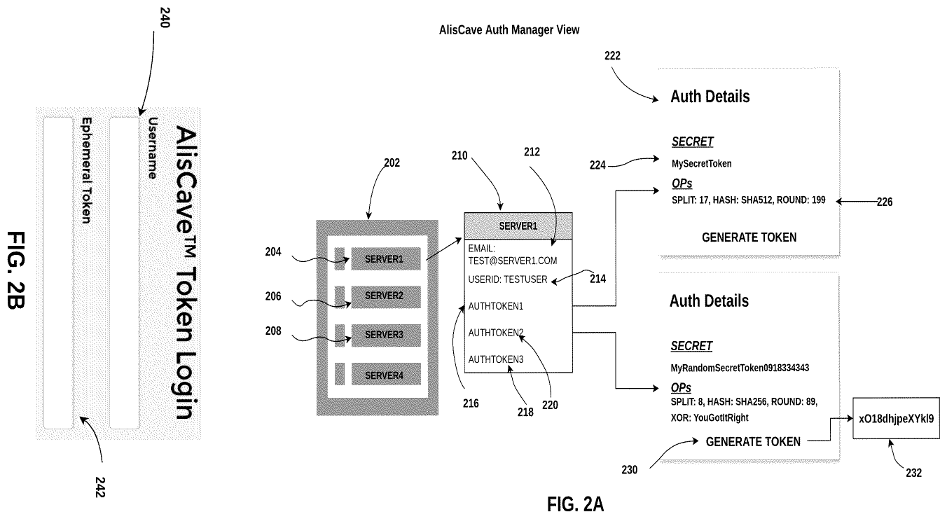

FIG. 2A illustrates an exemplary mobile app called AlisCave Auth Manager which is used as an authentication manager that works with the disclosed AlisCave Verifier. In this exemplary application the app displays (202) all the configured servers (204, 206, 208). Once user opens/taps on a particular server it shows the details of that server, for example when an user wants to see the details of server1 (204) it opens the view (210) of server1. The view (210) shows the details like, the email address (212) used during the registration, possible userid (214) and the available batch of authentication tokens (216, 218, 220). To use a particular token the user opens/taps on a particular authentication token (216) to see its details (222). The Auth Details view (222) displays the ACVD consist of the secret (224) and the OPs (226) used to generate the authentication token (AuthToken1) (216). The shown ACVD are prover created and stored locally in the mobile app. In this exemplary implementation only few possible OPs are shown, some other embodiments can use different OPs and this exemplary embodiment should be interpreted as demonstration purpose only rather than exhaustive list of possible OPs. The AlisCave Auth Manager can help maintain list of authentication tokens that is used for user authentication across various servers. Each Auth Details (222) view contains a Generate Token (230) functionality that can be used to request the AlisCave Auth server for an one-time ephemeral token that can be used for authentication through an web-based application accepting ephemeral token based authentication. When the user taps on the Generate Token (230) button the app prepares ACVD consisting the displayed items listed in SECRET (224) and OPs (226) section, then sends the ACVD to the verifier. The verifier receives the ACVD then checks the validity by generating authentication token and comparing with existing token (referring 112, 114), if the ACVD are valid the verifier creates a random generated token valid for a limited period of time (i.e. ephemeral token) and send the token back to the prover. The prover can use the so-called ephemeral token along with its unique ID for authentication. Such one-time ephemeral token makes it easier to use and require less typing/memorizing in case when the secrets or whole authentication details are long. This approach helps making the solution more usable and a viable alternative to the app generated 2FA that is currently used. The other aspect of the AlisCave Auth Manager application is it can maintain the authenticity by periodically synchronizing authentication tokens with the server. The AlisCave Auth Manager helps maintains credentials across multiple servers.

FIG. 2B illustrates a preferred exemplary user interface (UI) where an user can provide ephemeral token for login generated by AlisCave Auth Manager (referring FIG. 2A). This way the user need to posses the AlisCave Auth Manager during authentication the user need to provide the unique ID (240) and the AlisCave Auth Manager generated ephemeral token (242) (referring described functionality in 232). This approach is similar to token generation approach of Two-Factor Authentication (2FA) that apps like Google Authenticator or FreeOTP but differs in the internal implementation. The generated ephemeral token is based on the user provided ACVD which was previously registered and maintained by the AlisCave Auth Manager.

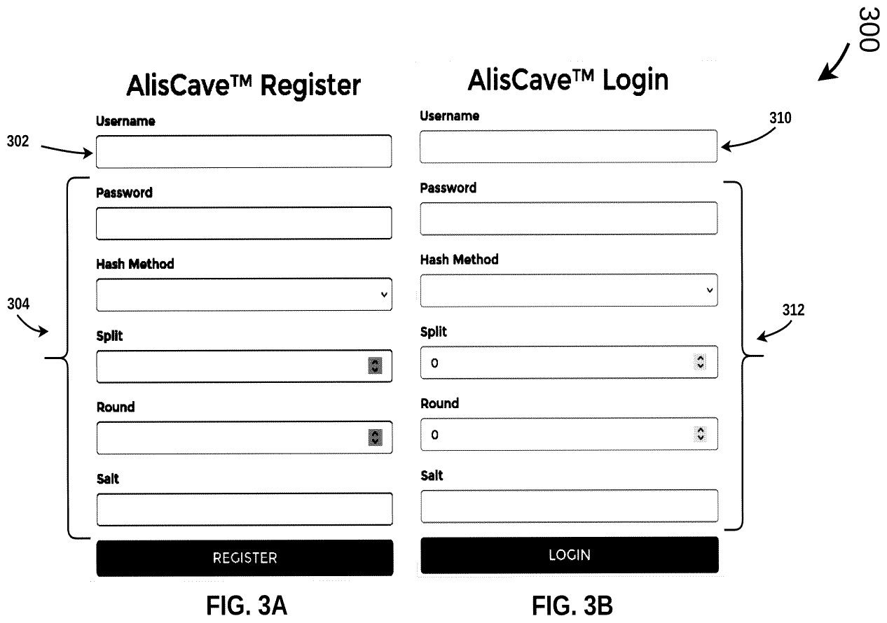

FIG. 3A and FIG. 3B illustrates a preferred exemplary implementation for new user registration and login view of a typical computer application wherein the application is used by an user or acting on behalf of a prover (300). During the creation of an user account (i.e. user registration) the user need to enter an unique ID (i.e. email/userid/username) (302). Then the user need to provide inputs which constructs the ACVD (308). In this exemplary embodiment, the ACVD consist of fields like password, hash method, split, round and salt but other embodiment may include fewer or more fields. Password, salt fields can be anything that an user provides (i.e. the data part of ACVD) and the split, round, hash method are generally verifier provided (i.e. the OPs part of ACVD) which the user picks from the list of provided options. For example, a verifier provides a list of hash methods like, SHA-256, RIPEMD-256, RIPEMD-512, SHA512, PBKDF2 or similar etc. and the prover picks a hash method from there. However some embodiment may allow provers to pick their own OPs field. In this way an user is getting involved in authentication token generation process, making the process dynamic and unpredictable compared to the existing process of fixed, server-side password hashing method. Some implementation may allow users to generate an arbitrary procedure for authentication token generation and shared with the verifer during authentication. Some embodiments may allow receiving the ACVD or the procedure from an external application.

In case of web-applications the client is responsible for fetching the content that is displayed to the user (i.e. provided by the web-server) therefore it's up to the server to provide the possible methods. Some other embodiments can implement in a way which is completely independent of the server. Whether an user is allowed to pick one or more OPs will depended on the specific implementation, some implementation may allow empty set of ACVD or force users to select at-least one parameter from the ACVD. Letting users to select an empty ACVD set makes the process less secure whereas proper utilizing of ACVD can generate strong token (i.e. more unpredictable). Once the required options are provided and the client application will generate the authentication token, then the generated authentication token will be sent to the server along with the unique ID. Some implementation may offer an API for receiving such inputs from external applications.

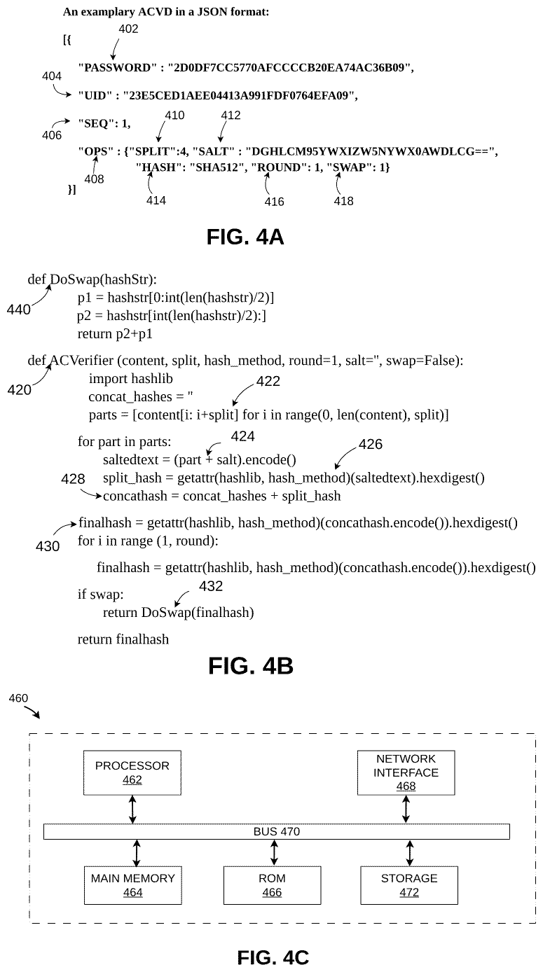

FIG. 4A illustrates an exemplary payload in JavaScript Object Notation (JSON) format that is received by the AlisCave Verifier. The verifier parses its content to generate the authentication token. Other embodiment may use different formats like, XML, Protobuf messaging format, YAML etc. or any custom designed format/protocol or any additional fields to meet any particular need. JSON uses key-value pair for holding information. The key named PASSWORD (402) holds a string indicating data part of the ACVD which are typically a secret or any randomly generated arbitrarily long string. The UID (404) is the user/prover specific identification. The SEQ (406) field holds a positive integer use to refer a payload among multiple payloads against an UID. An exemplary OPS (408) instructs what to do with the PASSWORD (402) by specifying various actions. SPLIT (410) indicates to split the PASSWORD value (23E5CED1AEE04413A991FDF0764EFA09 in this case) into 4 parts wherein the SPLIT can be a positive integer greater than 1 (>1 ) where 1 indicates no split and the maximum split depending on the content and implementation. SALT (412) can be applied before or after the split operation or maybe before generating the final hash, again this is highly implementation specific-some implementation may prefer to take such options as user input and provide appropriate user interface to receive such inputs or some implementation could be verifier provided. HASH (414) tells which hashing method to use to generate the hash of each parts of the content. In this preferred exemplary embodiment use of a single hash function has been shown but it is also possible to use multiple of hash functions. ROUND (416) is an action tells how many times a hash should be performed-an optional positive integer value default to 1. SWAP (418) is a boolean value indicating if the hashed content should be swapped-in such case-the final hash will be split into two parts and will change their position.

Some embodiment may use an procedure to generate the authenticate token and sent to the verifier. According to a disclosed preferred embodiment, a verification technique has been shown which relies on computer based hashing methods along with various string OPs comprising splitting, joining, swapping, shifting, XORing etc. Other embodiments can utilize different string operations or arithmetic or computer implemented operations. The key idea which differs from traditional authentication method is allowing various inputs from the prover and integrate them into the authentication token generation process, making the process prover's input driven rather a fixed, server implementation specific method. In this way the server offers authentication service without knowing the secrets and remains safe-guarded against server compromises. From the end users perspective-they don't need to trust the authentication service providers as they are controlling the process of generating the authentication token which is only known to them. In some other embodiments the payload contents may sent separately, for example sending the PASSWORD (402) first then separately sending the UID (404) and SEQ (406) in a step-by-step manner and tell the verifier what to do with the content. For example, unwrapping STEPS (408) and send each OPs separately, sending SPLIT (410) first, then SALT (412) and so on, this way the verifier applies the OPs over the content/data in a transactional manner to generate the authentication token. In such embodiment the verification may take place at each step by comparing the generated hash value at each step. For example, a prover can send the PASSWORD (402), the SPLIT (410) and a hash method in the first step, upon receiving the verifier applies those actions and generates a hash value, if the hash value matches the previously stored hash value then the verification step continues. In the second step the prover sends the remaining ACVD like, SALT (412), ROUND (416) indicating the verfier should apply them to the result from previous step and check if result from this step matches the previously stored result. Finally the prover sends the final set of ACVD and the verifier applies them to check if the result matches the final result. The number of steps, OPs are implementation specific.

FIG. 4B illustrates a preferred Python implementation indicating how the ACVD are parsed by the verifier and how the ACVD/the parameters and a so called procedure are connected. The ACVAVerifier (420) is a procedure that is used to generate the authentication token therefore maybe be used by both the prover and the verifier and the function parameters are the so-called ACVD (referring FIGS. 3A/3B). The disclosed embodiment shows how it breaks the content/password in chunks by split size and keeps it in a list called parts (422). The procedure creates a salted text (424) before calling the hash method (426). All the generated hash are put into a string (428). The final hash is created (430) from the concatenated hashed string with single round of hashing. If swapping is requested (432) then procedure DoSwap (440) is used for splitting the final hash value into two parts and exchanging their position. The ACVAVerifier (420) parameters can be extracted from the STEPS (410) (referring FIG. 4A). Some other embodiments may implement the procedure differently by reordering the hashing, using multiple hashing methods in different steps, splitting, swapping differently or may use different OPs (various computing operations) for authentication token generation. It is also possible to adopt different procedure for different prover, some implementation make the use of OPs optional, on the contrary, some implementation can be them mandatory. A prover may send the whole procedure ACVAVerifier (420) during authentication.

FIG. 4C illustrates certain components within a computer system (460). One or more computer systems (460) maybe used to implement and run the various devices, components, servers, the system, the services/methods described herein.

The computer system (460) includes a processor (462). The processor (462) may be a general-purpose or a special purpose single or multi-chip microprocessor (e.g., an Advanced RISC (Reduced Instruction Set Computer) Machine (ARM)), a special purpose microprocessor (e.g., a digital signal processor (DSP)), a micro-controller, a programmable gate array, etc. The processor (462) may be referred to as a central processing unit (CPU). Although just a single processor (462) is shown in the computer system, in an alternative configuration, a combination of processors (e.g., an ARM and DSP) could be used.

The computer system (460) further includes main memory (464) a form of volatile memory such as Random Access Memory (RAM) found in contemporary computing systems used in workstations, servers, Single Board Computers (SBC), System-on-Chip (SoC) or System-on-Module (SoM) etc. Main memory (464) may be used for storing program's instruction and data during execution of instructions to be executed by processor (462).

The computer system (460) further comprises a Read Only Memory (ROM) (466) a form of non-volatile memory which is limited in size and holds some key information required for the computer system to run properly. Typically ROM data is read by the processor when the system is powered up and has no data in the main memory (464), ROM holds the instructions that is to be loaded in the main memory (464), execute by the processor (462) and indicates all variants storage used for holding instructions required during system power up.

The other form of non-volatile memory the computer system (460) can have is storage (472) which can hold amount of data that is not suitable to store in other form of memories like, main memory (464) or ROM (466). The computer system (460) may need various program to conduct its operations, these programs may be written in various programming languages like, C, C++, Java etc. and storage (472) is a place where these programs are stored. Storage (472) is also the key hardware for providing support for storing various types of data which is used in the disclosed AlisCave verifier and the prover.

The computer system (460) uses network interface (468) for communicating with the other computer systems. The embodiment described in this disclosure makes active use of the network interface for sending/receiving messages that makes the whole system to work as intended. The computer system (460) may have different type of network interface (468) like wire based or wireless network interface.

All the components of the computer system (460), the processor (462), the network interface (468), the main memory (464), the ROM (466) and the storage (472) are connected via a common channel called bus (470).

### Technical Field

The present disclosure relates to the technical field of Cybersecurity, user authentication and application of Zero-Knowledge proof like approach to defend against server compromises.

1. An authentication system, the system comprising:
a network interface;
a storage device;
a processor;
wherein the system is configured to:
receive, a request with a parameter, the parameter comprising an unique id, an authentication token or a procedure or an ACVD wherein the procedure or the ACVD is used to generate an authentication token;
store, the received unique id and the authentication token wherein the authentication token may need to generate from the received procedure or the ACVD;
receive, an authentication request with a parameter, the parameter comprising an unique id, a procedure or an ACVD;
generate, an authentication token derived from the procedure or the ACVD received from the authentication request;
compare, the generated authentication token with the stored authentication token for the received unique id from the authentication request;
send, a response to the prover.

2. The system of claim 1, further configured to generate ephemeral authentication token valid for a limited period of time.

3. The system of claim 1, further configured as authentication service provider.

4. The computer system of claim 1, further configured to receive authentication request in multiple steps wherein each step is validated separately.

5. A registered prover verification method, the method comprising:
receiving, authentication/login request with a parameter, the parameter comprising an unique id and a procedure or an ACVD or an ephemeral token;
generating, an authentication token derived from the received procedure or the ACVD;
comparing, the generated authentication token or the ephemeral token with a stored authentication token for the requested unique id;
sending, a response to the prover.

6. The method of claim 5, wherein the authentication request parameters or the ACVD can be received in multiple steps.

7. An authentication request sending method, the method comprising:
receiving, an unique ID and a procedure or an ACVD or an ephemeral token from a prover;
sending, an authentication/login request comprising the unique ID and the procedure or the ACVD to a verifier wherein the procedure or the ACVD is used by the verifier to generate an authentication token;
receiving, a response from the verfier.

8. The method of claim 7, wherein the authentication/login request can be send in a transactional manner, i.e., sending the procedure or the ACVD in multiple steps.

9. An authentication request sending system, the system comprising:
a network interface;
a storage device;
a processor;
wherein the system is configured to:
receive, an unique ID and a procedure or an ACVD or an ephemeral token from a prover;
send, an authentication/login request comprising the unique ID and the procedure or the ACVD to a verifier wherein the procedure or the ACVD is used by the verifier to generate an authentication token;
receive, a response from the verifier.

10. The system of claim 9, further configured to send authentication/login request in a transactional manner i.e., sending the procedure or the ACVD in multiple steps.
